(19) United States
(12) Patent Application Publication
(10) Pub. No.: US 2025/0074816 A1
(43) Pub. Date: Mar. 6, 2025

(54) ION-EXCHANGE METHODS AND ION-EXCHANGED GLASS ARTICLES MADE USING THE SAME

(71) Applicant: CORNING INCORPORATED, CORNING, NY (US)

(72) Inventors: JIANGWEI FENG, NEWTOWN, PA (US); YUHUI JIN, PAINTED POST, NY (US); PETER JOSEPH LEZZI, CORNING, NY (US)

(21) Appl. No.: 18/286,298

(22) PCT Filed: Apr. 8, 2022
(86) PCT No.: PCT/US2022/023940

§ 371 Date: Oct. 10, 2023

Related U.S. Application Data
(60) Provisional application No. 63/175,740, filed on Apr. 16, 2021.

(51) Int. Cl. C03C 21/00; C03C 3/087; C03C 3/091

(52) U.S. Cl. CPC C03C 21/002; C03C 3/087; C03C 3/091

(57) ABSTRACT

Methods of making ion-exchanged glass articles including exposing the glass articles to a molten salt including 2 wt % to 10 wt % of an inorganic non-hydroxide salt sufficient to provide a pH from 9 to 12 when 5 grams of the inorganic non-hydroxide salt is dissolved in 100 grams of distilled water. The high-pH molten salts comprising the inorganic non-hydroxide salt can ion-exchange thin glass articles to have desirable mechanical performance without the use of a post-ion-exchange etching step. In some embodiments, the molten salt can include less than 1 wt % sodium nitrate (NaNO₃).

### CROSS-REFERENCE TO RELATED APPLICATION

This application claims the benefit of priority under 35 U.S.C. § 119 of U.S. Provisional Application Ser. No. 63/175,740 filed on Apr. 16, 2021, the content of which is relied upon and incorporated herein by reference in its entirety.

### FIELD

The present disclosure relates to ion-exchanged glass articles and methods of ion exchanging the glass articles. Specifically, embodiments described related to ion-exchanged glass articles for use in various industries, for example, consumer electronics, transportation, architecture, defense, medicine, and packaging. Even more specifically, the present disclosure relates to ion-exchanged glass articles for cover glass applications, for example, cover glass for an electronic display, like an LED or OLED display.

### BACKGROUND

Many consumer products, for example smart phones, tablets, portable media players, personal computers, and cameras, incorporate cover glasses that may function as display covers, and may incorporate touch functionality. Frequently, these devices are dropped by users onto hard surfaces, which can cause damage to the cover glasses, and may negatively affect the use of the devices, for example, the touch functionality may be compromised.

Foldable or flexible displays for consumer electronics applications may benefit from thin, flexible ion-exchanged glass. Glass can be made more resistant to impact and flexure failure through ion-exchange processes, which involve inducing compressive stresses on the glass surfaces. The compressive stress introduced using an ion-exchange process serves to, among other things, arrest flaws that can cause failure of the glass.

Therefore, a continuing need exists for ion-exchanged glass articles having desirable mechanical properties for use in a variety of applications, including cover glass applications.

### BRIEF SUMMARY

The present disclosure is directed to ion-exchange methods for efficiently making thin, ion-exchanged glass articles. The ion-exchange methods can utilize high-pH molten salt solutions to reduce the concentration of hydronium ions in the solutions during ion-exchange. By reducing the hydronium ion concentration, worsening of glass surface cracks and/or creation of new glass surface cracks during ion-exchange can be inhibited. In some embodiments, the sodium concentration in the molten slat solutions can be limited to help maximize the degree of surface compressive stress created during an ion-exchange process. By minimizing glass surface cracks and maximizing the degree of surface compressive stress, the ion-exchange methods can efficiently create high strength ion-exchanged articles. In particular, the ion-exchange methods can create high strength ion-exchanged articles without the use of a post-ion-exchange etching step configured to manipulate the mechanical properties of an ion-exchanged glass article.

A first aspect (1) of the present application is directed to a method of making an ion-exchanged glass article, the method including: exposing a glass article comprising a thickness ranging from 20 microns to 200 microns to a molten salt, the molten salt comprising: 2 wt % to 10 wt % of an inorganic non-hydroxide salt sufficient to provide a pH from 9 to 12 when 5 grams of the inorganic non-hydroxide salt is dissolved in 100 grams of distilled water, 85 wt % to 98 wt % potassium nitrate (KNO₃), and less than 1 wt % sodium nitrate (NaNO₃); and inducing a compressive stress region extending from a surface of the glass article to a depth of compression and comprising a compressive stress of 700 MPa or more by ion-exchange between the glass article and the molten salt.

In a second aspect (2), the molten salt according to the first aspect (1) comprises 5 wt % to 10 wt % of the inorganic non-hydroxide salt.

In a third aspect (3), the inorganic non-hydroxide salt according to the first aspect (1) or the second aspect (2) is selected from the group consisting of: potassium carbonate (K₂CO₃) or potassium phosphate (K₃PO₄).

In a fourth aspect (4), the molten salt according to any one of aspects (1)-(3) comprises a pH greater than 7.

In a fifth aspect (5), the molten salt according to any of one of aspects (1)-(4) comprises a pH ranging from 9 to 12.

In a sixth aspect (6), the molten salt according to any one of aspects (1)-(5) comprises a sodium concentration ranging from 900 ppm to 4000 ppm.

In a seventh aspect (7), in the method according to any one of aspects (1)-(6), before exposure to the molten salt, the glass article comprises an impact resistance defined by the capability of the surface of the glass article to avoid failure at a first average pen drop height of X cm, the glass article comprising the surface compressive stress of 700 MPa or more comprises an impact resistance defined by the capability of the surface of the glass article to avoid failure at a second average pen drop height of Y cm, the glass article comprising the surface compressive stress of 700 MPa or more is not subjected to an etching process configured to etch a layer from the surface of the glass article before the average second pen drop height is measured, the first average pen drop height and the second average pen drop height are measured according to a Pen Drop Test, and Y is greater than or equal to 80% of X.

In an eighth aspect (8), in the method according to the seventh aspect (7), Y ranges from 15 cm to 25 cm.

In a ninth aspect (9), the method according to any one of aspects (1)-(8) is devoid of an etching process configured to etch a layer from the surface of the glass article comprising the compressive stress of 700 MPa or more.

In a tenth aspect (10), the compressive stress according to any one of aspects (1)-(9) is 800 MPa or more.

In an eleventh aspect (11), the compressive stress according to any one of aspects (1)-(10) ranges from 800 MPa to 1100 MPa.

In a twelfth aspect (12), the depth of compression according to any one of aspects (1)-(11) is greater than 10% of the thickness of the glass article.

In a thirteenth aspect (13), the molten salt according to any one of aspects (1)-(12) comprises a temperature ranging from 350° C. to 500° C., and the glass article is exposed to the molten salt for a time period ranging from 5 minutes to 120 minutes.

In a fourteenth aspect (14), the glass article according to any one of aspects (1)-(13) comprises an alkali aluminosilicate glass.

In a fifteenth aspect (15), the glass article according to any one of aspects (1)-(13) comprises an alkali borosilicate glass.

In a sixteenth aspect (16) the glass article according to any one of aspects (1)-(13) comprises: 60 mol % to 70 mol % SiO₂, 7.5 mol % to 20 mol % Al₂O₃, 0.1 mol % to 7.5 mol % MgO, 12.5 mol % to 19 mol % Na₂O, and at least one of: 0.1 mol % to 4 mol % K₂O, 0.1 mol % to 5 mol % CaO, or 0.1 mol % to 5 mol % B₂O₃.

In a seventeenth aspect (17), the glass article according to any one of aspects (1)-(13) comprises: 65 mol % to 70 mol % SiO₂, 7.5 mol % to 12.5 mol % Al₂O₃, 2.5 mol % to 7.5 mol % MgO, and 12.5 mol % to 17.5 mol % Na₂O.

In an eighteenth aspect (18), the glass article according to any one of aspects (1)-(17) comprises less than 0.1 mol % Li₂O.

A nineteenth aspect (19) of the present application is directed to an electronic device comprising an electronic display, and a glass article comprising a thickness ranging from 20 microns to 200 microns disposed over the electronic display and ion-exchanged according to the method of any one of aspects (1)-(18).

In a twentieth aspect (20), the electronic device according to the nineteenth aspect (19) further comprises a housing comprising a front surface, a back surface, and side surfaces; and electrical components at least partially within the housing, the electrical components comprising a controller, a memory, and the electronic display, the electronic display at or adjacent the front surface of the housing, where the glass article forms at least a portion of the housing.

A twenty-first aspect (21) of the present application is directed to an ion-exchanged glass article, comprising: 65 mol % to 70 mol % SiO₂, 7.5 mol % to 12.5 mol % Al₂O₃, 2.5 mol % to 7.5 mol % MgO, 12.5 mol % to 17.5 mol % Na₂O; a thickness ranging from 20 microns to 200 microns; a compressive stress region extending from a surface of the glass article to a depth of compression and comprising a compressive stress of 700 MPa or more; and an impact resistance defined by the capability of the surface of the glass article to avoid failure at a pen drop height ranging from 15 cm to 25 cm, the pen drop height being measured according to a Pen Drop Test.

In a twenty-second aspect (22), the ion-exchanged glass article according to the twenty-first aspect (21) further comprises a depth of compression greater than 10% of the thickness of the glass article.

### BRIEF DESCRIPTION OF THE DRAWINGS

The accompanying figures, which are incorporated herein, form part of the specification and illustrate embodiments of the present disclosure. Together with the description, the figures further serve to explain the principles of and to enable a person skilled in the relevant art(s) to make and use the disclosed embodiments. These figures are intended to be illustrative, not limiting. Although the disclosure is generally described in the context of these embodiments, it should be understood that it is not intended to limit the scope of the disclosure to these particular embodiments. In the drawings, like reference numbers indicate identical or functionally similar elements.

FIGS. 1A and 1B illustrate a high-pH ion-exchange process according to some embodiments.

FIG. 2 illustrates a cross section of a glass article having compressive stress regions according to some embodiments.

FIG. 3A is a plan view of an exemplary electronic device incorporating a glass article according to any of the glass articles disclosed herein. FIG. 3B is a perspective view of the exemplary electronic device of FIG. 3A.

FIG. 4 is a graph of pen drop performance for various ion-exchanged glass articles.

### DETAILED DESCRIPTION

The following examples are illustrative, but not limiting, of the present disclosure. Other suitable modifications and adaptations of the variety of conditions and parameters normally encountered in the field, and which would be apparent to those skilled in the art, are within the spirit and scope of the disclosure.

The ion-exchange methods described herein facilitate the creation of thin ion-exchanged glass articles with high surface compressive stress and suitable mechanical performance. The ion-exchange methods efficiently produce thin glass articles with suitable mechanical performance by eliminating post-ion-exchange processing steps, for example by eliminating a post-ion-exchange etching step. By eliminating the use of a post-ion-exchange etching step, the ion-exchange processes can create high strength glass articles in a more cost effective manner that also eliminates the use of potentially harmful chemicals, like hydrofluoric acid (HF).

To achieve desirable mechanical strength, surfaces of ion-exchanged glass articles should have a small number of critical surface flaws in the form of surface cracks. Such surface cracks can compromise mechanical properties, for example impact resistance measured in a pen-drop performance test. If the ion-exchange process is not properly controlled, surface cracks can be created during ion-exchange and any existing surface cracks can become more severe (deeper and sharper) during ion-exchange.

The creation and/or worsening of surface cracks during ion-exchange can be mitigated using a post-ion-exchange chemical etching step configured to remove a surface layer from ion-exchanged surfaces of a glass article. Some known ion-exchange processes utilize such a post-ion-exchange etching step to improve (or recover) mechanical properties, for example impact resistance or resistance to bending failure, by removing a glass surface layer including surface flaws. The etching step can blunt the tips of surface cracks and improve mechanical properties, including pen-drop performance properties. However, the etching step can reduce the surface compressive stress (CS) because the top surface layer of glass (which can have the highest compressive stress value) is removed.

To achieve good bendability and impact resistance, thin glass articles described herein are subject to an ion-exchange (chemically strengthening) process to create high surface compressive stress (CS) at one or more surfaces of the article. Ion-exchange processes described herein are capable of chemically strengthening thin glass articles to have high surface compressive stress and excellent impact resistance measured by pen-drop performance in the absence of a post-ion-exchange etching step. In other words, thin glass articles can be ion-exchanged to achieve excellent pen-drop performance without the use of a post-ion-exchange etching step configured to remove a top surface layer of the glass.

Ion-exchange processes described herein can achieve excellent pen-drop performance without a post-ion-exchange etching step by controlling the pH of a molten salt solution used to ion-exchange a glass article. The molten salt can be maintained at a pH of greater than 7. By using a molten salt with a pH of greater than 7, the creation and/or worsening of surface cracks during ion-exchange can be mitigated. A pH of greater than 7 can be achieved by adding one or more additives to the molten salt before or during the ion-exchange process. In some embodiments, the one or more additives can be an inorganic non-hydroxide salt sufficient to provide a pH from 9 to 12 when 5 grams of the inorganic non-hydroxide salt is dissolved in 100 grams of distilled water.

The high pH of the molten salts described herein can mitigate the creation and/or worsening of surface cracks by reducing the concentration of hydronium ions (H₃O⁺) in the molten salt. Ion-exchange processes generate compressive stress (CS) on glass surfaces through monovalent cation (M⁺) exchange between the glass article and the molten salt. At the same time, hydronium ions (H₃O⁺) present in ion-exchange salts can exchange with cations (M⁺) in the glass according to the following reaction.

H₃O⁺ (molten salt)+M⁺ (Glass)→H₃O⁺ (glass)+M⁺ (molten salt) (Reaction 1)

As hydronium ions exchange into the glass, these ions can react with surface crack tips and make the tips deeper and more severe if the following reaction is allowed to occur.

≡Si—O—Si≡+H₃O⁺ (glass)→≡Si—OH+≡Si—OH₂⁺ (Reaction 2)

Additionally, the hydronium ions can create new surface cracks by reacting with the glass surface. The creation and/or worsening of surface cracks can directly result in a degradation of glass mechanical strength properties, for example Ring-On-Ring, ball drop, and pen drop performance. Generally, mechanical properties like pen drop performance are inversely related to the number and severity of glass surface cracks. Controlling the number and severity of glass surface cracks for thin glass articles, for example glass articles having a thickness less than 200 microns, can be particularly important because the mechanical properties of thin glass articles can be particularly sensitive to the presence of surface cracks.

There are at least two options for restricting the concentration of hydronium ions in a molten salt. Restricting the concentration of hydronium ions can be achieved by keeping the humidity in the environment surrounding the molten salt low. By keeping the humidity low, less water molecules will stay in the molten salt, thus minimizing the concentration of hydronium ions. Restricting the concentration of hydronium ions can additionally or alternatively be achieved by keeping the pH of the salt at higher than 7. At high pH values, the concentration of hydronium ions is much lower, and the ions are less likely to diffuse in to glass. In other words, Reaction 1 is prohibited by keeping the pH of the salt at higher than 7. Additives, for example carbonate ions, can increase the pH of the molten salt and consume hydronium ions in the salt according to the following reaction.

H₃O⁺ (molten salt)+2CO₃²⁻(molten salt)→2HCO₃⁺ (molten salt)+OH⁻ (molten salt) (Reaction 3)

The reaction converts the cations into anions, for example bicarbonate and hydroxide. Because the anions do not exchange with the glass composition, the anions do not carry water moieties into the glass or react with surface cracks. In addition to carbonate ions, other oxyanions including as phosphate, hydroxide, and sulfate oxyanions can mitigate the concentration of hydronium ions in the molten salt.

In some cases, a molten salt with a pH of higher than 7 can serve to blunt the crack tips by facilitating the following reaction.

SiO₂ (glass)+20H⁻ (molten salt)→SiO₃²⁻ (molten salt)+H₂O (molten salt) (Equation 4)

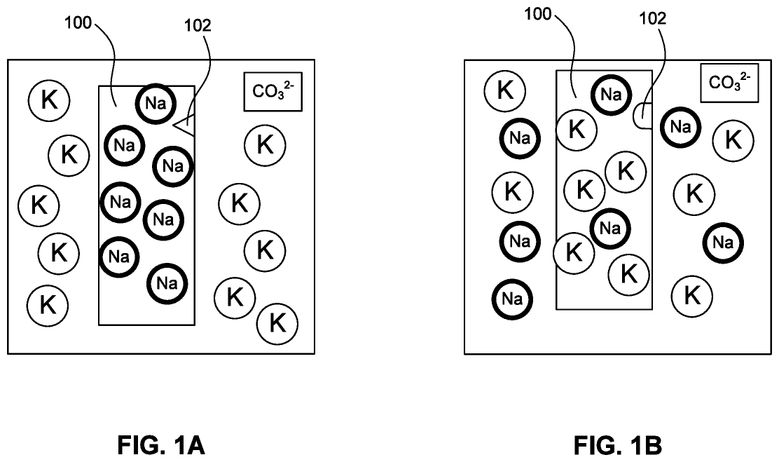

If Reaction 4 is properly controlled at a mild level, blunting of crack tips can be achieved without generating undesirable cosmetic surface defects resulting from the reaction byproduct (SiO₃²⁻) in Reaction 4. During an ion-exchange process with a pH of 7 or less, cracks having sharp tips at the surface of a glass article can be created and/or worsened. But, if the pH is raised to higher than 7, tips of cracks 102 at the surface of a glass article 100 can be blunted during ion-exchange and additional crack formation can be inhibited as shown in FIGS. 1A and 1B. Blunted crack tips are more resistant to crack growth when stress is applied to the glass article during, for example, an impact event or a bending event.

In some embodiments, ion-exchange processes described herein can achieve excellent pen-drop performance by controlling the pH of a molten salt solution and by limiting the sodium (Na) concentration of the molten salt. A high sodium (Na) concentration in the molten salt can diminish the degree of surface compressive stress (CS) created during an ion-exchange process. An increase in Na concentration can reduce the percentage of K+ (larger ions) in both a molten salt and at the glass surface, which as a result, can reduce the surface compressive stress (CS).

As shown in Table 1 below, increasing the weight percent of sodium nitrate (NaNO₃) in a molten salt can decrease the surface compressive stress for a glass article. The results shown in Table 1 are modeled results for the surface compressive stress on 100-micron thick glass article made of Composition #6 in Table 3 as a function of weight percent NaNO₃ in a molten salt ion-exchange bath. The remaining weight percent for each modeled molten salt was composed of potassium nitrate (KNO₃). The results show that for each 1 wt % (weight percent) increase of NaNO₃, the surface compressive stress drops by about 50 MPa. This trend was observed for all three modeled ion-exchange bath conditions (20 min @ 410° C., 45 min @ 410° C., and 90 min @ 410° C.).

TABLE 1
Modeled compressive stress values for different NaNO₃ concentrations

| | 20 min @ 410° C. | | 45 min @ 410° C. | | 90 min @ 410° C. | |
|---|---|---|---|---|---|---|
| wt % | CS | DOL | CS | DOL | CS | DOL |
| NaNO₃ | (MPa) | (μm) | (MPa) | (μm) | (MPa) | (μm) |
| 0.01 | 973 | 9.6 | 928 | 14.3 | 873 | 20.1 |
| 1 | 913 | 9.5 | 872 | 14.3 | 820 | 20.0 |
| 2 | 866 | 9.5 | 827 | 14.2 | 779 | 19.9 |
| 5 | 769 | 9.3 | 734 | 14.0 | 692 | 19.6 |
| 10 | 670 | 9.1 | 641 | 13.7 | 605 | 19.2 |

In some embodiments, the molten salt for an ion-exchange process can have less than 1 wt % sodium nitrate (NaNO₃). By limiting the weight percentage of sodium-containing elements like sodium nitrate, the sodium concentration of the bath can be limited. In some embodiments, the molten salt can comprise a sodium concentration of less than 4000 ppm (parts per million). Typical potassium nitrate (KNO₃) salt contains 0.2 wt % to 0.3 wt % of NaNO₃ impurity, which converts to about 900 ppm of Na+ ions in a molten salt bath composed of 100 wt % potassium nitrate. In some embodiments, the molten salt can comprise a sodium concentration ranging from 900 ppm to 4000 ppm, including subranges. For example, in some embodiments, the molten salt can comprise a sodium concentration ranging from 900 ppm to 4000 ppm, 900 ppm to 3000 ppm, or 900 ppm to 2000 ppm, or within a range having any two of these values as endpoints, inclusive of the endpoints.

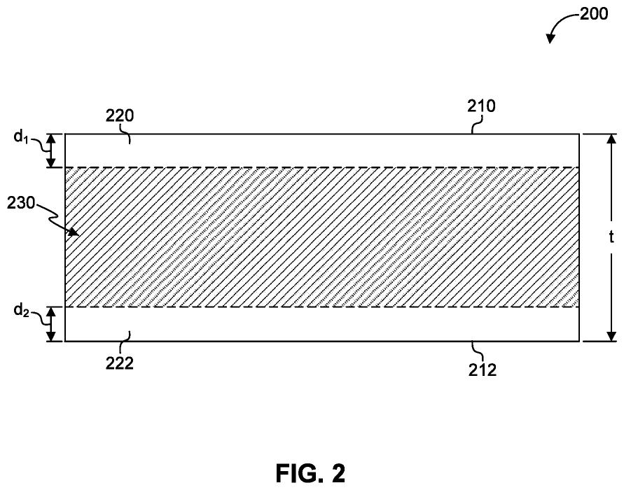

FIG. 2 shows a glass article 200 according to some embodiments. Glass article 200 includes a first surface 210 and a second surface 212 opposite first surface 210. Glass article 200 can have one or more surface regions under compressive stress. For example, glass article 200 can have a first surface region 220 (which can also referred to as first compressive stress region 220) and/or a second surface region 222 (which can also referred to as second compressive stress region 222) extending from exterior surfaces of glass article 200 (for example, surfaces 210, 212) to a depth of compression (DOC, d1, d2). Glass article 200 can also have a central region 230 between first surface region 220 and second surface region 222. Central region 230 can be under a tensile stress or CT extending from the DOC into the central or interior region of glass article 200. Ion-exchanged compressive stress regions 220, 222 can have a concentration of a metal oxide that is different at two or more points through a thickness (t) of glass article 200.

Thickness (t) of glass article 200 is measured between surface 210 and surface 212. In some embodiments, the thickness of glass article 200 can be 200 microns (micrometers, μm) or less. In some embodiments, the thickness of glass article 200 can range from 20 microns to 200 microns, including subranges. For example, the thickness of glass article 200 can range from 20 microns to 200 microns, 20 microns to 150 microns, 20 microns to 100 microns, 20 microns to 50 microns, 50 microns to 200 microns, 100 microns to 200 microns, or 150 microns to 200 microns, or within a range having any two of these values as endpoints, inclusive of the endpoints. In some embodiments, the thickness of glass article 200 can range from 20 microns to 200 microns. In some embodiments, the thickness of glass article 200 can range from 20 microns to 150 microns. In some embodiments, the thickness of glass article 200 can range from 20 microns to 100 microns. In some embodiments, the thickness of glass article 200 can range from 50 microns to 100 microns.

As used herein, “depth of compression” (DOC) refers to the depth at which the stress within a glass article changes from compressive to tensile. At the DOC, the stress crosses from a compressive stress to a tensile stress and thus exhibits a stress value of zero.

According to the convention normally used in the art, compression or compressive stress (CS) is expressed as a negative (<0) stress and tension or tensile stress is expressed as a positive (>0) stress. But throughout this description, and unless otherwise specified, CS is expressed as a positive or absolute value—for example, as recited herein, CS=|CS|. CS can vary with distance d from an exterior surface of glass article 200 according to a function. In some embodiments, the CS can have a maximum at an exterior surface of glass article 200. Unless specified otherwise, CS values are reported herein are CS values at an exterior surface of glass article 200.

Unless specified otherwise, a compressive stress (including surface CS) is measured by surface stress meter (FSM) using commercially available instruments for example the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient.”

Referring again to FIG. 2, first compressive stress region 220 extends from first surface 210 to a depth d₁ and second compressive stress region 222 extends from second surface 212 to a depth d₂. Together, these compressive stress regions 220, 222 define the compression region or CS region of glass article 200. The compressive stress of both regions 220 and 222 is balanced by stored central tension (CT) in central region 230 of glass article 200. Unless specified otherwise, CT values are reported as maximum CT values and CT values are reported as absolute values.

DOC can be measured by a surface stress meter or a scattered light polariscope (SCALP) depending on the ion-exchange treatment and the thickness of the article being measured. Where the stress in the substrate is generated by exchanging potassium ions into the substrate, a surface stress meter, for example, the FSM-6000 (Orihara Industrial Co., Ltd., Japan), is used to measure depth of compression. Where the stress is generated by exchanging sodium ions into the substrate, and the article being measured is thicker than about 400 microns, SCALP is used to measure the depth of compression and maximum central tension (CT). Where the stress in the substrate is generated by exchanging both potassium and sodium ions into the glass and the article being measured is thicker than about 400 microns, the depth of compression and CT are measured by SCALP. Without wishing to be bound by theory, the exchange depth of sodium can indicate the depth of compression while the exchange depth of potassium ions can indicate a change in the magnitude of the compressive stress (but not necessarily the change in stress from compressive to tensile). As used herein, “depth of layer” (DOL) refers to the depth within a glass article at which an ion of a metal oxide (for example, sodium or potassium) diffuses into the glass article where the concentration of the ion reaches a minimum value. In embodiments where only potassium is ion-exchanged into a glass article, DOC can equal DOL. Unless specified otherwise herein, the DOC and DOL of an ion-exchanged glass article are equal to each other. When the article being measured is thinner than about 400 microns, the maximum central tension can be measured using SCALP by sandwiching the article between two other glass articles with index oil to create an effectively thicker part and measuring the thickness of the part before the SCALP measurement to access the location of the center.

The refracted near-field (RNF) method may be used to derive a graphical representation of a glass article's stress profile. When the RNF method is utilized to derive a graphical representation of the stress profile, the maximum CT value provided by SCALP is utilized in the RNF method. In particular, the stress profile measured by RNF is force balanced and calibrated to the maximum CT value provided by a SCALP measurement. The RNF method is described in U.S. Pat. No. 8,854,623, entitled “Systems and methods for measuring a profile characteristic of a glass sample”, which is incorporated herein by reference in its entirety. In particular, the RNF method includes placing the glass article adjacent to a reference block, generating a polarization-switched light beam that is switched between orthogonal polarizations at a rate of from 1 Hz to 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal. The RNF method can be inaccurate over the first two microns of the glass article's depth. So the stress at the surface of the glass article can be measured with a surface stress meter, and extrapolated from the rest of the curve measured by RNF.

When a SCALP measurement is performed, it is done using a SCALP polariscope (e.g., SCALP-04 or SCALP-05), available from GlassStress Ltd., Talinn, Estonia. The precise sample speed SS and exposure times the to reduce the measurement noise in the polarimeter to an acceptable level when measuring a sample to characterize at least one stress-related characteristic depends on a number of factors. These factors include the characteristics of the image sensing device (e.g., the gain, image capture rate (frames/second), pixel size, internal pixel average techniques, etc.), as well as the nature of the no-stress-related (NSR) scattering feature(s), the intensity of the input light beam, the number of polarization states used, etc. Other factors include the measurement wavelength of the light beam from the laser source and the intensity of the scattered light beam. Example measurement wavelengths can include 640 nanometers (nm), 518 nm and 405 nm. Example exposure times can range from 0.05 millisecond to 100 milliseconds. Example frame rates can range from 10 to 200 frames per second. Example calculations of the optical retardation can utilize from two to two-hundred frames over a measurement time t_{M} of from 0.1 seconds to 10 seconds.

In some embodiments, the DOC of region 220 and/or region 222 can range from 9 microns (μm, micrometers) to 20 microns, including subranges. For example, in some embodiments, the DOC of region 220 and/or region 222 can range from 9 microns to 20 microns, 9 microns to 19 microns, 9 microns to 18 microns, 9 microns to 17 microns, 9 microns to 16 microns, 9 microns to 15 microns, 9 microns to 14 microns, 9 microns to 13 microns, 9 microns to 12 microns, 9 microns to 11 microns, 9 microns to 10 microns, 10 microns to 20 microns, 11 microns to 20 microns, 12 microns to 20 microns, 13 microns to 20 microns, 14 microns to 20 microns, 15 microns to 20 microns, 16 microns to 20 microns, 17 microns to 20 microns, 18 microns to 20 microns, or 19 microns to 20 microns, or within a range having any two of these values as endpoints, inclusive of the endpoints.

In some embodiments, DOC can be reported as a portion of the thickness (t) of glass article 200. In some embodiments, glass article 200 can have a depth of compression (DOC) that is greater than 10% of the thickness (0.1t) of glass article 200. In some embodiments, glass article 200 can have a depth of compression (DOC) ranging from 10% of the thickness (0.1t) of glass article 200 to 25% of the thickness (0.25t) of glass article 200, including subranges. For example, in some embodiments, glass article 200 can have a depth of compression (DOC) ranging from 0.1t to 0.25t, 0.1t to 0.20t, 0.1t to 0.15t, 0.15t to 0.25t, or 0.20t to 0.25t, or within a range having any two of these values as endpoints, inclusive of the endpoints.

Compressive stress regions 220, 222 can be formed in glass article 200 by exposing glass article 200 to one or more ion-exchange solutions. The ion-exchange solution can be a molten salt having a pH greater than 7. In some embodiments, the ion-exchange solution can be a molten salt having a pH ranging from 9 to 12. A molten salt having a pH greater than 12 can create dimples on the surfaces of a glass article during ion-exchange. The formation of these dimples can result in a glass article having undesirable optical properties. In some embodiments, the ion-exchange solution can be a molten salt having a pH ranging from 9 to 11.

A pH value for a molten salt described herein is the pH value of a solution consisting of 5 grams of an additive dissolved in 100 grams of distilled (DI) water. The additive is the one or more additives added to a molten salt bath otherwise consisting of only molten potassium nitrate (KNO₃) and sodium nitrate (NaNO₃). The additive can be one or more additives (for example, potassium carbonate (K₂CO₃) and/or potassium phosphate (K₃PO₄)). If there are two or more additives, the total mass of additives remains at 5 grams, and the mass of each additive is proportional to the proportional mass of each additive added to the molten salt. For example, if equal amounts of two additives are added to a molten salt, 2.5 grams of each additive is dissolved in the 100 grams of distilled water. The pH value of this representative DI water solution is used as the surrogate of the pH for a molten salt because the pH of a molten salt is not easily measured directly.

The molten salt can include potassium nitrate (KNO₃) at a weight percent within any of the ranges listed below. In some embodiments, the molten salt can include potassium nitrate (KNO₃) at a weight percent within any of the ranges listed below and sodium nitrate (NaNO₃) at any of the ranges listed below. In some embodiments, the molten salt can include potassium nitrate (KNO₃) at a weight percent within any of the ranges listed below, sodium nitrate (NaNO₃) at any of the ranges listed below, and one or more additives sufficient to provide a pH from 9 to 12 when 5 grams of the additive(s) is dissolved in 100 grams of distilled water. In some embodiments, the molten salt can include potassium nitrate (KNO₃) at a weight percent within any of the ranges listed below, sodium nitrate (NaNO₃) at any of the ranges listed below, and one or more inorganic non-hydroxide salts at a weight percent within any of the ranges listed below.

The molten salt can be composed primarily of potassium nitrate (KNO₃). In some embodiments, the molten salt can comprise 85 wt % or more KNO₃. In some embodiments, the molten salt can comprise 85 wt % to 98 wt % KNO₃, including subranges. For example, in some embodiments, the molten salt can comprise 85 wt % to 98 wt %, 85 wt % to 95 wt %, 85 wt % to 90 wt %, 90 wt % to 98 wt %, or 95 wt % to 98 wt % KNO₃.

In some embodiments, the molten salt can comprise a small amount of sodium nitrate (NaNO₃). In such embodiments, the NaNO₃ amount is minimized to minimize the sodium (Na) concentration in the molten salt, and thus avoid undesirably low (for some applications) values for surface compressive stress (for example, a surface compressive stress below 700 MPa or below 800 MPa). In some embodiments, the molten salt can comprise less than 1 wt % NaNO₃. For example, in some embodiments, the molten salt can comprise 0.3 wt % NaNO₃ to 0.99 wt % NaNO₃, 0.3 wt % NaNO₃ to 0.95 wt % NaNO₃, or 0.3 wt % NaNO₃ to 0.90 wt % NaNO₃.

In some embodiments, the molten salt can comprise an additive sufficient to provide a pH from 9 to 12 when 5 grams of the additive is dissolved in 100 grams of distilled water. In some embodiments, the additive can be one or more inorganic non-hydroxide salts sufficient to provide a pH from 9 to 12 when 5 grams of the one or more inorganic non-hydroxide salts are dissolved in 100 grams of distilled water.

In some embodiments, the molten salt can comprise 2 wt % to 10 wt % of the one or more inorganic non-hydroxide salts sufficient to provide a pH from 9 to 12 when 5 grams of the one or more inorganic non-hydroxide salts are dissolved in 100 grams of distilled water, including subranges. For example, in some embodiments, the molten salt can comprise 2 wt % to 10 wt %, 3 wt % to 10 wt %, 4 wt % to 10 wt %, 5 wt % to 10 wt %, 6 wt % to 10 wt %, 7 wt % to 10 wt %, 8 wt % to 10 wt %, 2 wt % to 8 wt %, 2 wt % to 7 wt %, 2 wt % to 6 wt %, 2 wt % to 5 wt %, or 2 wt % to 4 wt % of the one or more inorganic non-hydroxide salts. In some embodiments, the molten salt can comprise 5 wt % to 10 wt % of the one or more inorganic non-hydroxide salts.

As a non-limiting example, the molten salt can comprise 2 wt % to 10 wt % of a inorganic non-hydroxide salt sufficient to provide a pH from 9 to 12 when 5 grams of the inorganic non-hydroxide salt is dissolved in 100 grams of distilled water, 85 wt % to 98 wt % potassium nitrate (KNO₃), and less than 1 wt % sodium nitrate (NaNO₃).

In some embodiments, the inorganic non-hydroxide salt is a carbonate salt or a phosphate salt. In some embodiments, the inorganic non-hydroxide salt can be selected from the group consisting of: potassium carbonate (K₂CO₃) or potassium phosphate (K₃PO₄). In some embodiments, the molten salt can comprise potassium carbonate (K₂CO₃) as an inorganic non-hydroxide salt. In some embodiments, the molten salt can comprise potassium phosphate (K₃PO₄) as an inorganic non-hydroxide salt. In some embodiments, the molten salt can comprise potassium carbonate (K₂CO₃) or potassium phosphate (K₃PO₄) as an inorganic non-hydroxide salt. In some embodiments, the molten salt can comprise potassium carbonate (K₂CO₃) and potassium phosphate (K₃PO₄) as inorganic non-hydroxide salts.

Exposing the glass article to the molten salt solution can induce a compressive stress region (for example, compressive stress region 220) extending from a surface (for example, surface 210) of the glass article to a depth of compression comprising a compressive stress by ion-exchange between the glass article and the molten salt.

In some embodiments, the compressive stress induced by exposing the glass article to the molten salt can be 700 MPa (megapascals) or more. In some embodiments, the compressive stress induced by exposing the glass article to the molten salt can be 800 MPa or more. In some embodiments, the compressive stress induced by exposing the glass article to the molten salt can be 900 MPa or more. In some embodiments, the compressive stress induced by exposing the glass article to the molten salt can range from 700 MPa to 1100 MPa, including subranges. For example, in some embodiments, the compressive stress can range from 700 MPa to 1100 MPa, 800 MPa to 1100 MPa, 900 MPa to 1100 MPa, 1000 MPa to 1100 MPa, 700 MPa to 1000 MPa, 700 MPa to 900 MPa, or 700 MPa to 800 MPa. In some embodiments, the compressive stress induced by exposing the glass article to the molten salt can range from 800 MPa to 1100 MPa. In some embodiments, the compressive stress induced by exposing the glass article to the molten salt can range from 900 MPa to 1100 MPa.

Exposing the glass article to the molten salt solution can improve the pen drop performance of the glass article. This improved pen drop performance can be realized without performing a post-ion-exchange etching step. Before exposure to the molten salt, the glass article can comprise an impact resistance defined by the capability of a surface of the glass article to avoid failure at a first average pen drop height of X cm (centimeters). After exposure to the molten salt, the glass article can comprise an impact resistance defined by the capability of the surface of the glass article to avoid failure at a second average pen drop height of Y cm. According to embodiments of the present application, the glass article is not subjected to an etching process configured to etch a layer from the surface of the glass article before the second average pen drop height is measured. As such, according to embodiments of the present application, the method of making an ion-exchanged glass article can be devoid of an etching process configured to etch a layer from the surface of the glass article after ion-exchanging the glass article to have a surface compressive stress

In some embodiments, Y can be greater than or equal to 80% of X. In some embodiments, Y can be greater than or equal to 85% of X. In some embodiments, Y can be greater than or equal to 90% of X.

In some embodiments, Y can be 15 cm or more. In some embodiments, Y can range from 15 cm to 25 cm. In some embodiments, can Y range from 17.5 cm to 22.5 cm.

As a non-limiting example according to some embodiments, a glass article can comprise: pre-ion-exchange impact resistance defined by the capability of a surface of the glass article to avoid failure at a first average pen drop height of X cm, a post-ion-exchange induced surface compressive stress of 700 MPa or more, and a post-ion-exchange impact resistance defined by the capability of the surface of the glass article to avoid failure at a second average pen drop height of Y cm, where the glass article comprising the surface compressive stress of 700 MPa or more is not subjected to an etching process configured to etch a layer from the surface of the glass article before the second average pen drop height is measured, the first average pen drop height and the second average pen drop height are measured according to a Pen Drop Test, and Y is greater than or equal to 80% of X, greater than or equal to 85% of X, or greater than or equal to 90% of X. The method of making the glass article according to this embodiment can be devoid of an etching process configured to etch a layer from the surface of the glass article comprising the compressive stress of 700 MPa or more.

As a non-limiting example according to some embodiments, a glass article can comprise: pre-ion-exchange impact resistance defined by the capability of a surface of the glass article to avoid failure at a first average pen drop height of X cm, a post-ion-exchange induced surface compressive stress of 800 MPa or more, and a post-ion-exchange impact resistance defined by the capability of the surface of the glass article to avoid failure at a second average pen drop height of Y cm, where the glass article comprising the surface compressive stress of 800 MPa or more is not subjected to an etching process configured to etch a layer from the surface of the glass article before the second average pen drop height is measured, the first average pen drop height and the second average pen drop height are measured according to a Pen Drop Test, and Y is greater than or equal to 80% of X, greater than or equal to 85% of X, or greater than or equal to 90% of X. The method of making the glass article according to this embodiment can be devoid of an etching process configured to etch a layer from the surface of the glass article comprising the compressive stress of 800 MPa or more.

As a non-limiting example according to some embodiments, a glass article can comprise: pre-ion-exchange impact resistance defined by the capability of a surface of the glass article to avoid failure at a first average pen drop height of X cm, a post-ion-exchange induced surface compressive stress of 900 MPa or more, and a post-ion-exchange impact resistance defined by the capability of the surface of the glass article to avoid failure at a second average pen drop height of Y cm, where the glass article comprising the surface compressive stress of 900 MPa or more is not subjected to an etching process configured to etch a layer from the surface of the glass article before the second average pen drop height is measured, the first average pen drop height and the second average pen drop height are measured according to a Pen Drop Test, and Y is greater than or equal to 80% of X, greater than or equal to 85% of X, or greater than or equal to 90% of X. The method of making the glass article according to this embodiment can be devoid of an etching process configured to etch a layer from the surface of the glass article comprising the compressive stress of 900 MPa or more.

As a non-limiting example according to some embodiments, a glass article can comprise: pre-ion-exchange impact resistance defined by the capability of a surface of the glass article to avoid failure at a first average pen drop height of X cm, a post-ion-exchange induced surface compressive stress ranging from 800 MPa to 1100 MPa, and a post-ion-exchange impact resistance defined by the capability of the surface of the glass article to avoid failure at a second average pen drop height of Y cm, where the glass article comprising the surface compressive stress ranging from 800 MPa to 1100 MPa is not subjected to an etching process configured to etch a layer from the surface of the glass article before the second average pen drop height is measured, the first average pen drop height and the second average pen drop height are measured according to a Pen Drop Test, and Y is greater than or equal to 80% of X, greater than or equal to 85% of X, or greater than or equal to 90% of X. The method of making the glass article according to this embodiment can be devoid of an etching process configured to etch a layer from the surface of the glass article comprising the compressive stress ranging from 800 MPa to 1100 MPa.

As described and referred to herein, a “Pen Drop Test” is conducted such that samples of glass articles are tested with the load (for example, from a pen dropping at a certain height) imparted to a surface of a glass article with the opposite surface of the glass article bonded to a 100 micron thick layer of polyethylene terephthalate (PET) with a 50 micron thick optically transparent adhesive layer. The PET layer in the Pen Drop Test is meant to simulate a flexible electronic display device (e.g., an OLED device). During testing, the glass article bonded to the PET layer is placed on an aluminum plate (6063 aluminum alloy, as polished to a surface roughness with 400 grit paper) with the PET layer in contact with the aluminum plate. No tape is used on the side of the sample resting on the aluminum plate.

A tube is used for the Pen Drop Test to guide a pen to the sample, and the tube is placed in contact with the top surface of the sample so that the longitudinal axis of the tube is substantially perpendicular to the top surface of the sample. The tube has an outside diameter of 2.54 cm (1 inch), an inside diameter of 1.4 cm (nine sixteenths of an inch) and a length of up to 90 cm. An acrylonitrile butadiene (“ABS”) shim is employed to hold the pen at a desired height for each test. After each drop, the tube is relocated relative to the sample to guide the pen to a different impact location on the sample. The pen employed in the Pen Drop Test is a BIC® Easy Glide Pen, Fine, having a tungsten carbide ball point tip of 0.7 mm diameter, and a weight of 5.73 grams including the cap (4.68 g without the cap). A comparable pen-like object with similar mass, aerodynamic properties, and a 0.7 mm diameter tungsten carbide ball tip may also be used.

For the Pen Drop Test, the pen is dropped with the cap attached to the top end (i.e., the end opposite the tip) so that the ball point can interact with the test sample. In a drop sequence according to the Pen Drop Test, one pen drop is conducted at an initial height of 1 cm, followed by successive drops in 1 cm increments up to 20 cm, and then after 20 cm, 2 cm increments until failure of the test sample. After each drop is conducted, the presence of any observable fracture, failure, or other evidence of damage to the glass article is recorded along with the particular pen drop height. Using the Pen Drop Test, multiple samples can be tested according to the same drop sequence to generate a population with improved statistics. For the Pen Drop Test, the pen is to be changed to a new pen after every 5 drops, and for each new sample tested. In addition, all pen drops are conducted at random locations on the sample at or near the center of the sample, with no pen drops near or on the edge of the samples. For an “average pen drop height,” at least three samples are tested according to the Pen Drop Test and the average pen drop height is reported.

For purposes of the Pen Drop Test, “failure” means the formation of a mechanical defect in a glass article that is visible to eyes having 20/20 vision. The mechanical defect may be a crack or plastic deformation (e.g., surface indentation). The crack may be a surface crack or a through crack. The crack may be formed on an interior or exterior surface of a glass article. The crack may extend through all or a portion of the layers of a glass article.

A glass article can be exposed to an ion-exchange solution by immersing the glass article into a bath of the ion-exchange solution, spraying the ion-exchange solution onto the glass article, or otherwise physically applying the ion-exchange solution to the glass article. Upon exposure to the glass article, the ion-exchange solution can, according to some embodiments, be at a temperature from greater than or equal to 350° C. to less than or equal to 550° C. and all ranges and sub-ranges between the foregoing values. For example, in some embodiments, the temperature can range from 350° C. to 550° C., 350° C. to 525° C., 350° C. to 500° C., 350° C. to 475° C., 350° C. to 450° C., 350° C. to 425° C., 350° C. to 400° C., 350° C. to 375° C., 375° C. to 550° C., 400° C. to 550° C., 425° C. to 550° C., 450° C. to 550° C., 475° C. to 550° C., 500° C. to 550° C., or 525° C. to 550° C., or within a range having any two of these values as endpoints, inclusive of the endpoints. In some embodiments, the temperature can range from 350° C. to 500° C.

In some embodiments, a glass article can be exposed to an ion-exchange solution for a duration from greater than or equal to 5 minutes to less than or equal to 120 minutes, and all ranges and sub-ranges between the foregoing values. For example, in some embodiments, the duration can range from 5 minutes to 120 minutes, 5 minutes to 90 minutes, 5 minutes to 60 minutes, 5 minutes to 30 minutes, 5 minutes to 15 minutes, 15 minutes to 120 minutes, 30 minutes to 120 minutes, 60 minutes to 120 minutes, or 90 minutes to 120 minutes, or within a range having any two of these values as endpoints, inclusive of the endpoints.

Thin ion-exchanged glass articles having desirable properties can be made using the ion-exchange processes described herein. As a non-limiting example, a glass article according to embodiments of the present application can comprise a thickness ranging from 20 microns to 200 microns, a compressive stress region extending from a surface of the glass article to a depth of compression and comprising a compressive stress of 700 MPa or more, and an impact resistance defined by the capability of the surface of the glass article to avoid failure at an average pen drop height ranging from 15 cm to 25 cm, the average pen drop height being measured according to a Pen Drop Test. The thickness (t) of the glass article can range from 20 microns to 200 microns, or within any range described herein. The compressive stress region can comprise a compressive stress of 700 MPa or more, or a compressive stress within any range described herein. In some embodiments, the impact resistance can be defined by the capability of the surface of the glass article to avoid failure at an average pen drop height ranging from 17.5 cm to 22.5 cm. In some embodiments, the depth of compression of the compressive stress region can be greater than 10% of the thickness of the glass article.

After one or more ion-exchange processes are performed, it should be understood that a composition at the surface of a glass article can be different than the composition of the as-formed glass article (for example, the glass article before it undergoes an ion-exchange process). This results from one type of alkali metal ion in the as-formed glass, for example Nat, being replaced with larger alkali metal ions, for example K+. However, the glass composition at or near the center of the depth of the glass article will, in some embodiments, still have the composition of the as-formed glass article. Unless specified otherwise, glass compositions disclosed in this application are compositions of the glass article near the center of the depth of the article where the composition is unaffected (or is least affected) by an ion-exchange process, i.e., the composition of the as-formed glass article before it undergoes an ion-exchange process. In other words, glass compositions disclosed in this application can be compositions of the glass article in the central region of the glass article.

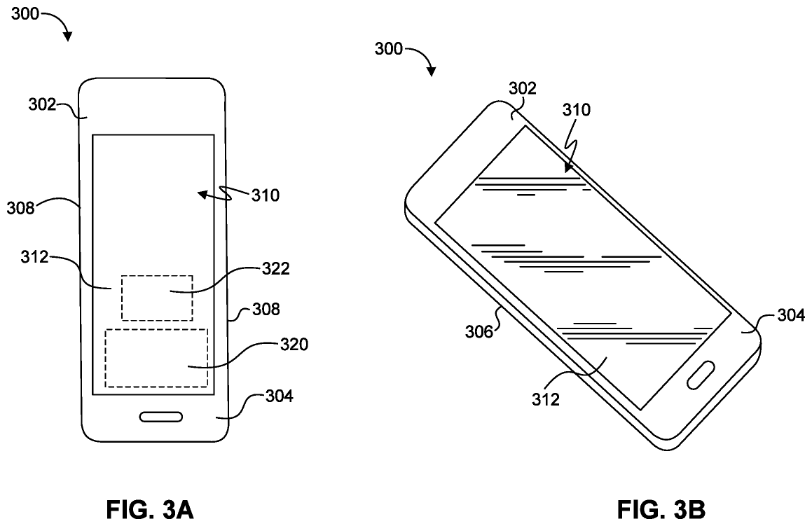

The glass articles disclosed herein can be incorporated into another article for example an article with a display (or display articles) (e.g., consumer electronics, including mobile phones, watches, tablets, computers, navigation systems, and the like), architectural articles, transportation articles (e.g., automobiles, trains, aircraft, sea craft, etc.), appliance articles, or any article that may benefit from some transparency, scratch-resistance, abrasion resistance, or a combination thereof. An exemplary article incorporating any of the glass articles disclosed herein is shown in FIGS. 3A and 3B. Specifically, FIGS. 3A and 3B show a consumer electronic product 300 including a housing 302 having a front surface 304, a back surface 306, and side surfaces 308. Electrical components that are at least partially inside or entirely within the housing can include at least a controller 320, a memory 322, and a display 310 at or adjacent to front surface 304 of housing 302. Display 310 can be, for example, a light emitting diode (LED) display or an organic light emitting diode (OLED) display.

A cover substrate 312 can be disposed at or over front surface 304 of housing 302 such that it is disposed over display 310. Cover substrate 312 can include any of the glass articles disclosed herein and may be referred to as a “cover glass.” Cover substrate 312 can serve to protect display 310 and other components of consumer electronic product 300 (e.g., controller 320 and memory 322) from damage. In some embodiments, cover substrate 312 can be bonded to display 310 with an adhesive. In some embodiments, cover substrate 312 can define all or a portion of front surface 304 of housing 302. In some embodiments, cover substrate 312 can define front surface 304 of housing 302 and all or a portion of side surfaces 308 of housing 302. In some embodiments, consumer electronic product 300 can include a cover substrate defining all or a portion of back surface 306 of housing 302.

### Examples

Embodiments will be further clarified by the following examples. It should be understood that these examples are not limiting to the embodiments described above. To demonstrate the effectiveness of the high-pH ion-exchange molten salts and processes described herein, 100-micron thick 50 mm by 50 mm glass article samples made of Composition #6 in Table 3 were ion-exchanged under various conditions and tested for pen drop performance according to the Pen Drop Test. The glass samples are made using a redraw process and were cut to size using a CO₂ laser.

The following four ion-exchange conditions were used. Condition A: ion-exchange for 60 minutes at 410° C. using a molten salt composition of 99.5 wt % KNO₃ and 0.5 wt % KOH. Condition B: ion-exchange for 60 minutes at 410° C. using a molten salt composition of 95 wt % KNO₃ and 5 wt % K₂CO₃. Condition C: ion-exchange for 60 minutes at 410° C. using a molten salt composition of 100 wt % KNO₃. Condition D: ion-exchange for 60 minutes at 410° C. using a molten salt composition of 100 wt % KNO₃ with a post-ion-exchange etching step using 0.58 M hydrofluoric acid (HF) and 0.8 M nitric acid (HNO₃) to remove about a 1.3-micron thick surface layer of glass from both sides of the glass article.

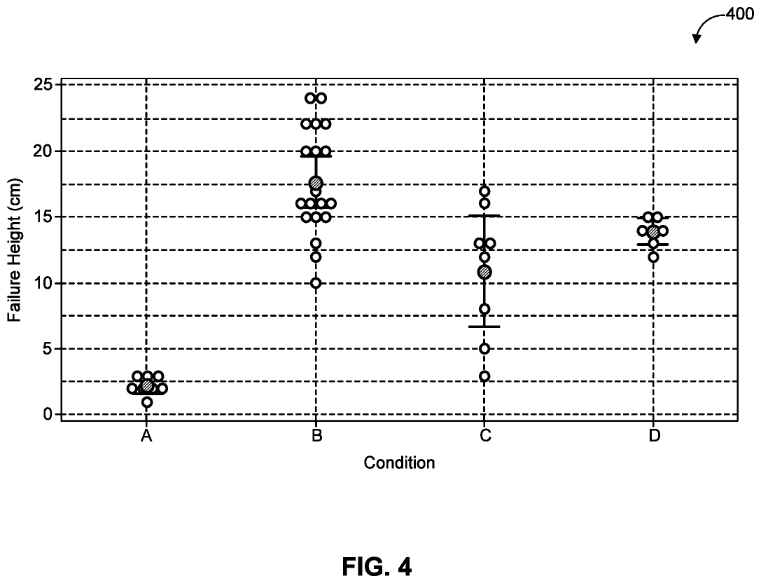

After ion-exchange (and after the etching step for Condition D), the glass samples were a cleaned in a detergent having a pH 12 for 12 minutes at 70° C., followed by a DI water rinse and drying in a cleanroom. The surface compressive stress (CS) and depth of layer (DOL) for representative glass samples were measured using a surface stress meter. The compressive stress (CS) and depth of layer (DOL) are shown below in Table 2. The depth of layer (DOL) of the glass articles is equal to the depth of compression (DOC) of the glass articles. Graph 400 in FIG. 4 shows the pen drop test results for glass samples ion-exchanged according to Conditions A-D, and the average pen drop measurements for the glass samples are reported in Table 2. For comparison, the average pen drop value of non-ion-exchanged glass samples made of Composition #6 was also measured and is reported in Table 2.

TABLE 2
Surface compressive stress (CS), depth of layer (DOL), and pen
drop height measurements for representative glass samples

| Ion-exchange | | | Average Pen |
|---|---|---|---|
| Condition | CS (MPa) | DOL (microns) | Drop Height (cm) |
| A | 983 | 19.2 | 2.3 |
| B | 960 | 17.4 | 17.6 |
| C | 935 | 17.9 | 10.9 |
| D | 825 | 16.8 | 13.9 |
| N/A (control) | N/A | N/A | 19.5 |

The pen drop data shows that an ion-exchange process using a high pH molten salt with 5 wt % carbonate additive (Condition B) effectively produces a glass article with suitable surface compressive strength. Without a post-ion-exchange etching step, the average pen drop height for Condition B is about 17.6 cm. Glass samples ion-exchanged according to Condition C using a molten salt having a pH of 7 exhibited a much lower pen drop height of about 10.9 cm. The results for Condition D also show that, even if Condition C is combined with a post-ion-exchange etching step, the pen drop performance is still lower (average failure height of about 13.9 cm) than that for Condition B.

On the other end, when molten salt pH is too high—a pH of close to 13 created in Condition A with 0.5 wt % KOH)—surface Reaction 4 starts to generate byproduct (SiO₃²⁻) and blocks intended glass ion-exchange reactions, which creates poor optical and mechanical strength properties. Samples ion-exchanged according to Condition A exhibited surface dimples and an average pen drop height of about 2.3 cm.

### Glass Compositions

As used herein, the term “glass” is meant to include any material made at least partially of glass, including glass and glass-ceramics. “Glass-ceramics” include materials produced through controlled crystallization of glass. One or more nucleating agents, for example, titanium oxide (TiO₂), zirconium oxide (ZrO₂), sodium oxide (Na₂O), and phosphorus oxide (P₂O₅) may be added to a glass-ceramic composition to facilitate homogenous crystallization.

For glass compositions described herein, the concentration of constituent components (e.g., SiO₂, Al₂O₃, Na₂O, and the like) are given in mole percent (mol %) on an oxide basis, unless otherwise specified. Components of the glass compositions according to embodiments are discussed individually below. It should be understood that any of the variously recited ranges of one component may be individually combined with any of the variously recited ranges for any other component. As used herein, a trailing 0 in a number is intended to represent a significant digit for that number. For example, the number “1.0” includes two significant digits, and the number “1.00” includes three significant digits. As used herein, a composition described as including an oxide within a range defined by 0 mol % as the lower bound means that the composition includes the oxide at any amount above 0 mol % (e.g., 0.01 mol % or 0.1 mol %) and up to the upper bound of the range.

As used herein, the term “substantially free” means that the component is not added as a component of the batch material even though the component may be present in the final glass in very small amounts as a contaminant. As a result of the raw materials and/or equipment used to produce a glass composition of the present disclosure, certain impurities or components that are not intentionally added, can be present in the final glass composition. Such materials are present in the glass composition in minor amounts, referred to “tramp materials.” A composition that is “substantially free” of a component means that the component was not purposefully added to the composition, but the composition may still comprise the component in tramp or trace amounts. A composition that is “substantially free” of an oxide means that the oxide is present at an amount less than or equal to 0.1 mol %, for example 0 mol % to less than or equal to 0.1 mol %. As used herein, a glass composition that is “free” of a component, is defined as meaning that the component (e.g., oxide) is not present in the composition, even in tramp or trace amounts.

The glass composition can include a plurality of oxides selected from the group of: silicon oxide (SiO₂), aluminum oxide (Al₂O₃), sodium oxide (Na₂O), magnesium oxide (MgO), calcium oxide (CaO), boron oxide (B₂O₃), potassium oxide (K₂O), or zirconium oxide (ZrO₂) at any of the mol % ranges listed below. In some embodiments, the glass composition can include three or more of these oxides. In some embodiments, the glass composition can include four or more of these oxides. In some embodiments, the glass composition can include five or more of these oxides. In some embodiments, the glass composition can include six or more of these oxides. In some embodiments, the glass composition can include all seven of these oxides.

In some embodiments, the glass composition can be an alkali aluminosilicate glass. In some embodiments, the glass composition can be an alkali borosilicate glass. Table 3 below shows some exemplary glass compositions (C1-C9) according to some embodiments.

TABLE 3
Exemplary glass compositions

| | C1 | C2 | C3 | C4 | C5 | C6 | C7 | C8 | C9 |
|---|---|---|---|---|---|---|---|---|---|
| SiO₂ | 60.36 | 62.92 | 67.39 | 66.1 | 66.1 | 68.95 | 68.95 | 67.55 | 69.2 |
| Al₂O₃ | 19.17 | 16.27 | 11.46 | 10.36 | 10.36 | 10.27 | 10.07 | 12.67 | 8.52 |
| B₂O₃ | — | — | — | — | — | — | — | 3.68 | — |
| MgO | 1.81 | 2.96 | 4.71 | 7.33 | 3.83 | 5.36 | 4.86 | 2.33 | 6.44 |
| CaO | 1.72 | 1.19 | — | — | — | 0.05 | 0.52 | — | 0.54 |
| Na₂O | 16.84 | 16.53 | 14.9 | 12.85 | 17.85 | 15.2 | 15.43 | 13.67 | 13.94 |
| K₂O | — | — | 1.39 | 2.72 | 1.22 | — | — | — | 1.17 |
| SnO₂ | 0.1 | 0.13 | 0.15 | 0.12 | 0.12 | 0.17 | 0.17 | 0.1 | 0.19 |
| ZrO₂ | — | — | — | 0.52 | 0.52 | — | — | — | — |

SiO₂ may be the largest constituent in the glass composition and, as such, is the primary constituent of the glass network formed from the glass composition. Pure SiO₂ has a relatively low coefficient of thermal expansion (CTE—as used herein this property is measured at a temperature from 0° C. to 300° C.) and is alkali free. However, pure SiO₂ has a high melting point. Accordingly, if the concentration of SiO₂ in the glass composition is too high, the formability of the glass composition may be diminished as higher concentrations of SiO₂ increase the difficulty of melting the glass, which, in turn, adversely impacts the formability of the glass.

In some embodiments, the glass composition can include SiO₂ in an amount from 60 mol % to 70 mol %, and all ranges and subranges between the foregoing values. In some embodiments, the glass composition can include SiO₂ in an amount of 60 mol % or more, 61 mol % or more, 62 mol % or more, 63 mol % or more, 64 mol % or more, 65 mol % or more, 66 mol % or more, 67 mol % or more, 68 mol % or more, 69 mol % or more, or 70 mol %. In some embodiments, the glass composition can include SiO₂ in an amount of 69 mol % or less, 68 mol % or less, 67 mol % or less, 66 mol % or less, 65 mol % or less, 64 mol % or less, 63 mol % or less, 62 mol % or less, 61 mol % or less, or 60 mol %.

Any of the above SiO₂ ranges can be combined with any other range. For example, in some embodiments, the glass composition can include SiO₂ in an amount of 60 mol % to 70 mol %, 61 mol % to 70 mol %, 62 mol % to 70 mol %, 63 mol % to 70 mol %, 64 mol % to 70 mol %, 65 mol % to 70 mol %, 66 mol % to 70 mol %, 67 mol % to 70 mol %, 68 mol % to 70 mol %, or 69 mol % to 70 mol %, and all ranges and sub-ranges having any two of the above-listed SiO₂ values as endpoints, including the endpoints. In some embodiments, the glass composition can include SiO₂ in a range of 65 mol % to 70 mol %.

In some embodiments, the glass composition can include Al₂O₃. The addition of Al₂O₃ can serve as a glass network former. Furthermore, when the concentration of Al₂O₃ is balanced against the concentration of SiO₂ and the concentration of alkali oxides in the composition, it can reduce the liquidus temperature of the glass melt, thereby enhancing the liquidus viscosity.

In some embodiments, the glass composition can include Al₂O₃ at a concentration ranging from 7.5 mol % to 20 mol %, and all ranges and sub-ranges between the foregoing values. In some embodiments, the glass composition can include Al₂O₃ in an amount of 7.5 mol % or more, 8 mol % or more, 9 mol % or more, 10 mol % or more, 11 mol % or more, 12 mol % or more, 12.5 mol % or more, 13 mol % or more, 14 mol % or more, 15 mol % or more, 16 mol % or more, 17 mol % or more, 18 mol % or more, 19 mol % or more, or 20 mol %. In some embodiments, the glass composition can include Al₂O₃ in an amount of 20 mol % or less, 19 mol % or less, 18 mol % or less, 17 mol % or less, 16 mol % or less, 15 mol % or less, 14 mol % or less, 13 mol % or less, 12.5 mol % or less, 12 mol % or less, 11 mol % or less, 10 mol % or less, 9 mol % or less, 8 mol % or less, or 7.5 mol %.

Any of the above Al₂O₃ ranges can be combined with any other range. For example, in some embodiments, the glass composition can include Al₂O₃ in an amount of 7.5 mol % to 20 mol %, 7.5 mol % to 19 mol %, 7.5 mol % to 18 mol %, 7.5 mol % to 17 mol %, 7.5 mol % to 16 mol %, 7.5 mol % to 15 mol %, 7.5 mol % to 14 mol %, 7.5 mol % to 13 mol %, 7.5 mol % to 12.5 mol %, 7.5 mol % to 12 mol %, 7.5 mol % to 11 mol %, 7.5 mol % to 10 mol %, 7.5 mol % to 9 mol %, or 7.5 mol % to 8 mol %, and all ranges and sub-ranges having any two of the above-listed Al₂O₃ values as endpoints, including the endpoints. In some embodiments, the glass composition can include Al₂O₃ in an amount of 7.5 mol % to 12.5 mol %.

In some embodiments, the glass composition can include Na₂O. Na₂O can aid in the ion-exchangeability of the glass composition, and improve the formability, and thereby manufacturability, of the glass composition. However, if too much Na₂O is added to the glass composition, the CTE may be too low, and the melting point may be too high. In some embodiments, the glass composition can include Na₂O at a concentration of 12 mol % or more to 20 mol % or less, and all ranges and sub-ranges between the foregoing values. In some embodiments, the glass composition can include Na₂O in an amount of 12 mol % or more, 12.5 mol % or more, 13 mol % or more, 14 mol % or more, 15 mol % or more, 16 mol % or more, 17 mol % or more, 17.5 mol % or more, 18 mol % or more, 19 mol % or more, or 20 mol %. In some embodiments, the glass composition can include Na₂O in an amount of 20 mol % or less, 19 mol % or less, 18 mol % or less, 17.5 mol % or less, 17 mol % or less, 16 mol % or less, 15 mol % or less, 14 mol % or less, 13 mol % or less, 12.5 mol % or less, or 12 mol %.

Any of the above Na₂O ranges can be combined with any other range. For example, in some embodiments, the glass composition can include Na₂O in an amount from 12 mol % to 20 mol %, 12.5 mol % to 19 mol %, 13 mol % to 18 mol %, or 13.5 mol % to 17.5 mol %, and all ranges and sub-ranges having any two of the above-listed Na₂O values as endpoints, including the endpoints. In some embodiments, the glass composition can include Na₂O in an amount from 12.5 mol % to 17.5 mol %.

In some embodiments, the glass composition can include MgO. MgO can lower the viscosity of a glass, which enhances the formability and manufacturability of the glass. The inclusion of MgO in a glass composition can also improve the strain point and the Young's modulus of the glass composition, as well as the ion-exchange-ability of the glass. However, if too much MgO is added to the glass composition, the density and the CTE of the glass composition may increase to undesirable levels.

In some embodiments, the glass composition can include MgO at a concentration of from 0.1 mol % or more to 7.5 mol % or less, and all ranges and sub-ranges between the foregoing values. In some embodiments, the glass composition may include MgO in an amount of 0.1 mol % or more, 1 mol % or more, 2 mol % or more, 2.5 mol % or more, 5 mol % or more, or 7.5 mol %. In some embodiments, the glass composition can include MgO in an amount of 7.5 mol % or less, 5 mol % or less, 2.5 mol % or less, 2 mol % or less, 1 mol % or less, or 0.1 mol %.

Any of the above MgO ranges can be combined with any other range. For example, in some embodiments, the glass composition can include MgO in an amount of 0.1 mol % to 7.5 mol %, 1 mol % to 7.5 mol %, 2 mol % to 7.5 mol %, 2.5 mol % to 7.5 mol %, or 5 mol % to 7.5 mol %, and all ranges and sub-ranges having any two of the above-listed MgO values as endpoints, including the endpoints. In some embodiments, the glass composition can include MgO in a range of 2.5 mol % to 7.5 mol %.

In some embodiments, the glass composition can include CaO. CaO can lower the viscosity of a glass (which may enhance the formability), the strain point, and the Young's modulus, and may improve the ion-exchange-ability of the glass. However, if too much CaO is added to the glass composition, the density and the CTE of the glass composition may increase to undesirable levels.

In some embodiments, the glass composition can include CaO at a concentration of 0.1 mol % or more to 5 mol % or less, and all ranges and sub-ranges between the foregoing values. In some embodiments, the glass composition can include CaO in an amount of 0.1 mol % or more, 1 mol % or more, 2 mol % or more, 3 mol % or more, 4 mol % or more, or 5 mol %. In some embodiments, the glass composition can include CaO in amount of 5 mol % or less, 4 mol % or less, 3 mol % or less, 2 mol % or less, 1 mol % or less, or 0.1 mol %.

Any of the above CaO ranges can be combined with any other range. For example, in some embodiments, the glass composition can include CaO in an amount of 0.1 mol % to 5 mol %, 0.1 mol % to 4 mol %, or 0.1 mol % to 2 mol %, and all ranges and sub-ranges having any two of the above-listed CaO values as endpoints, including the endpoints. In some embodiments, the glass composition can include CaO in a range of 0.1 mol % to 5 mol %.

In some embodiments, the glass composition can include B₂O₃. In some embodiments, the glass composition can include B₂O₃ at a concentration of 0.1 mol % or more to 5 mol % or less, and all ranges and sub-ranges between the foregoing values. In some embodiments, the glass composition can include B₂O₃ in an amount of 0.1 mol % or more, 1 mol % or more, 2 mol % or more, 3 mol % or more, 4 mol % or more, or 5 mol %. In some embodiments, the glass composition can include B₂O₃ in amount of 5 mol % or less, 4 mol % or less, 3 mol % or less, 2 mol % or less, 1 mol % or less, or 0.1 mol %.

Any of the above B₂O₃ ranges may be combined with any other range. For example, in some embodiments, the glass composition may include B₂O₃ in an amount of 0.1 mol % to 5 mol %, 0.1 mol % to 4 mol %, or 0.1 mol % to 2 mol %, and all ranges and sub-ranges having any two of the above-listed B₂O₃ values as endpoints, including the endpoints. In some embodiments, the glass composition can include B₂O₃ in a range of 0.1 mol % to 5 mol %.

In some embodiments, the glass composition can include K₂O. In some embodiments, the glass composition can include K₂O at a concentration of 0.1 mol % or more to 4 mol % or less, and all ranges and sub-ranges between the foregoing values. In some embodiments, the glass composition can include K₂O in an amount of 0.1 mol % or more, 1 mol % or more, 2 mol % or more, 3 mol % or more, or 4 mol %. In some embodiments, the glass composition can include K₂O in amount of 4 mol % or less, 3 mol % or less, 2 mol % or less, 1 mol % or less, or 0.1 mol %.

Any of the above K₂O ranges can be combined with any other range. For example, in some embodiments, the glass composition can include K₂O in an amount of 0.1 mol % to 4 mol %, 0.1 mol % to 2 mol %, or 0.1 mol % to 1 mol %, and all ranges and sub-ranges having any two of the above-listed K₂O values as endpoints, including the endpoints. In some embodiments, the glass composition can include K₂O in a range of 0.1 mol % to 4 mol %.

In some embodiments, the glass composition can include ZrO₂. In some embodiments, the glass composition can include ZrO₂ at a concentration of 0.1 mol % or more to 1 mol % or less, and all ranges and sub-ranges between the foregoing values. In some embodiments, the glass composition can include ZrO₂ in an amount of 0.1 mol % or more, 0.5 mol % or more, 0.75 mol % or more, or 1 mol %. In some embodiments, the glass composition can include ZrO₂ in amount of 1 mol % or less, 0.75 mol % or less, 0.5 mol % or less, or 0.1 mol %.

Any of the above ZrO₂ ranges can be combined with any other range. For example, in some embodiments, the glass composition can include ZrO₂ in an amount of 0.1 mol % to 1 mol %, 0.1 mol % to 0.75 mol %, or 0.1 mol % to 0.5 mol %, and all ranges and sub-ranges having any two of the above-listed ZrO₂ values as endpoints, including the endpoints.

In some embodiments, the glass composition can include one or more fining agents. In some embodiments, the fining agents can include, for example, tin oxide (SnO₂). In such embodiments, SnO₂ can be present in the glass composition at an amount less than or equal to 2 mol %, such as from greater than 0.1 mol % to less than or equal to 2 mol %, and all ranges and sub-ranges between the foregoing values. In some embodiments, SnO₂ can be present in the glass composition at an amount from greater than 0.1 mol % to less than or equal to 1.5 mol %, or greater than or equal to 0.1 mol % to less than or equal to 1 mol %, and all ranges and sub-ranges between the foregoing values. In some embodiments, the glass composition can be free of or substantially free of SnO₂.

In some embodiments, the fining agents can include, for example, iron oxide (Fe₂O₃). In such embodiments, Fe₂O₃ can be present in the glass composition at an amount less than or equal to 0.1 mol %, for example from greater than 0 mol % to less than or equal to 0.1 mol %. In some embodiments, the glass composition can be free of or substantially free of Fe₂O₃.

In some embodiments, the glass composition can be free or substantially free of one or more of: ZnO, SrO, BaO, P₂O₅, and Li₂O. In some embodiments, the glass composition can be free or substantially free of all of: ZnO, SrO, BaO, P₂O₅, and Li₂O. Some of these oxides can be expensive and/or in limited supply. The alkali earth metal oxides can undesirably increase Young's modulus and can slow an ion-exchange process. P₂O₅ can decrease the amount of compressive stress imparted during an ion-exchange process. In some embodiments, the glass composition can comprise less than 0.1 mol % Li₂O.

While various embodiments have been described herein, they have been presented by way of example, and not limitation. It should be apparent that adaptations and modifications are intended to be within the meaning and range of equivalents of the disclosed embodiments, based on the teaching and guidance presented herein. It therefore will be apparent to one skilled in the art that various changes in form and detail can be made to the embodiments disclosed herein without departing from the spirit and scope of the present disclosure. The elements of the embodiments presented herein are not necessarily mutually exclusive, but may be interchanged to meet various situations as would be appreciated by one of skill in the art.

Embodiments of the present disclosure are described in detail herein with reference to embodiments thereof as illustrated in the accompanying drawings, in which like reference numerals are used to indicate identical or functionally similar elements. References to “one embodiment,” “an embodiment,” “some embodiments,” “in certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The examples are illustrative, but not limiting, of the present disclosure. Other suitable modifications and adaptations of the variety of conditions and parameters normally encountered in the field, and which would be apparent to those skilled in the art, are within the spirit and scope of the disclosure.

The indefinite articles “a” and “an” to describe an element or component means that one or more than one of these elements or components is present. Although these articles are conventionally employed to signify that the modified noun is a singular noun, as used herein the articles “a” and “an” also include the plural, unless otherwise stated in specific instances. Similarly, the definite article “the,” as used herein, also signifies that the modified noun may be singular or plural, again unless otherwise stated in specific instances.

Directional terms as used herein—for example up, down, right, left, front, back, top, bottom, inward, outward—are made only with reference to the figures as drawn and are not intended to imply absolute orientation.

As used in the claims, “comprising” is an open-ended transitional phrase. A list of elements following the transitional phrase “comprising” is a non-exclusive list, such that elements in addition to those specifically recited in the list may also be present. As used in the claims, “consisting essentially of” or “composed essentially of” limits the composition of a material to the specified materials and those that do not materially affect the basic and novel characteristic(s) of the material. As used in the claims, “consisting of” or “composed entirely of” limits the composition of a material to the specified materials and excludes any material not specified.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. Whether or not a numerical value or end-point of a range recites “about,” the numerical value or end-point of a range is intended to include two embodiments: one modified by “about,” and one not modified by “about.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, for example within about 5% of each other, or within about 2% of each other.

The present embodiment(s) have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

It is to be understood that the phraseology or terminology used herein is for the purpose of description and not of limitation. The breadth and scope of the present disclosure should not be limited by any of the above-described exemplary embodiments, but should be defined in accordance with the following claims and their equivalents.

1. A method of making an ion-exchanged glass article, the method comprising:
exposing a glass article comprising a thickness ranging from 20 microns to 200 microns to a molten salt, the molten salt comprising:
2 wt % to 10 wt % of an inorganic non-hydroxide salt sufficient to provide a pH from 9 to 12 when 5 grams of the inorganic non-hydroxide salt is dissolved in 100 grams of distilled water,
85 wt % to 98 wt % potassium nitrate (KNO₃), and
less than 1 wt % sodium nitrate (NaNO₃); and
inducing a compressive stress region extending from a surface of the glass article to a depth of compression and comprising a compressive stress of 700 MPa or more by ion-exchange between the glass article and the molten salt.

2. The method of claim 1, wherein the molten salt comprises 5 wt % to 10 wt % of the inorganic non-hydroxide salt.

3. The method of claim 1, wherein the inorganic non-hydroxide salt is selected from the group consisting of: potassium carbonate (K₂CO₃) or potassium phosphate (K₃PO₄).

4. The method of claim 1, wherein the molten salt comprises a pH greater than 7.

5. The method of claim 1, wherein the molten salt comprises a pH ranging from 9 to 12.

6. The method of claim 1, wherein the molten salt comprises a sodium concentration ranging from 900 ppm to 4000 ppm.

7. The method of claim 1, wherein:
before exposure to the molten salt, the glass article comprises an impact resistance defined by the capability of the surface of the glass article to avoid failure at a first average pen drop height of X cm,
the glass article comprising the surface compressive stress of 700 MPa or more comprises an impact resistance defined by the capability of the surface of the glass article to avoid failure at a second average pen drop height of Y cm,
the glass article comprising the surface compressive stress of 700 MPa or more is not subjected to an etching process configured to etch a layer from the surface of the glass article before the average second pen drop height is measured,
the first average pen drop height and the second average pen drop height are measured according to a Pen Drop Test, and
Y is greater than or equal to 80% of X.

8. The method of claim 7, wherein Y ranges from 15 cm to 25 cm.

9. The method of claim 1, wherein the method is devoid of an etching process configured to etch a layer from the surface of the glass article comprising the compressive stress of 700 MPa or more.

10. The method of claim 1, wherein the compressive stress is 800 MPa or more.

11. The method of claim 1, wherein the compressive stress ranges from 800 MPa to 1100 MPa.

12. The method of claim 1, wherein the depth of compression is greater than 10% of the thickness of the glass article.

13. The method of claim 1, wherein the molten salt comprises a temperature ranging from 350° C. to 500° C., and wherein the glass article is exposed to the molten salt for a time period ranging from 5 minutes to 120 minutes.

14. The method of claim 1, wherein the glass article comprises an alkali aluminosilicate glass.

15. The method of claim 1, wherein the glass article comprises an alkali borosilicate glass.

16. The method of claim 1, wherein the glass article comprises:
60 mol % to 70 mol % SiO₂;
7.5 mol % to 20 mol % Al₂O₃;
0.1 mol % to 7.5 mol % MgO;
12.5 mol % to 19 mol % Na₂O; and
at least one of: 0.1 mol % to 4 mol % K₂O, 0.1 mol % to 5 mol % CaO, or 0.1 mol % to 5 mol % B₂O₃.

17. The method of claim 1, wherein the glass article comprises:
65 mol % to 70 mol % SiO₂;
7.5 mol % to 12.5 mol % Al₂O₃;
2.5 mol % to 7.5 mol % MgO; and
12.5 mol % to 17.5 mol % Na₂O.

18. The method of claim 1, wherein the glass article comprises less than 0.1 mol % Li₂O.

19. An electronic device, comprising:
an electronic display; and
a glass article comprising a thickness ranging from 20 microns to 200 microns disposed over the electronic display and ion-exchanged according to the method of claim 1.

20. The electronic device of 19, further comprising a housing comprising a front surface, a back surface, and side surfaces; and electrical components at least partially within the housing, the electrical components comprising a controller, a memory, and the electronic display, the electronic display at or adjacent the front surface of the housing, wherein the glass article forms at least a portion of the housing.

21-22. (canceled)
